(19) United States
(12) Patent Application Publication
(10) Pub. No.: US 2005/0274054 A1
(43) Pub. Date: Dec. 15, 2005

(54) No-tie lure connection system

(76) Inventor: William J. Warman, Mesa, AZ (US)

Correspondence Address: WILLIAM J. WARMAN SR., 11341 E. ADOBE RD., MESA, AZ, 85207, US

(21) Appl. No.: 10/872,955

(22) Filed: Jun. 12, 2004

(51) Int. Cl. A01K 85/00

(52) U.S. Cl. 43/42.49

(57) ABSTRACT

This new process of a fishing lure will allow a child to tie a fishing lure on a line. The No-Tie Lure system is a new invention that all fishing lures not to be tied directly to a fishing lure, but easy enough to allow a child to install it. The No-Tie lure will enable the handicap to tie a fishing lure on without a knot being tied directly to an eyelet. This is the simplest fishing lure to attach in the world. Stick the line trough the No-Tie Lure Connector. Tie a overhand knot Pull the knot tight. Cut of any access line, and pull the knot up into the No-Tie Lure Connector. The lure is now attached and ready for fishing. The No-Tie Lure system is an improvement to every fishing lure known today. The No-Tie Lure system is an improvement in all aspects to the lure that exist today.

### REFERENCES CITED

### FIELD OF SEARCH

43/42.06,42.02,42.23,42.52,42.03,42.35,42.5,42.08

| | | | |
|---|---|---|---|
| 6,574,909 | Hoffman | Jun. 10, 2003 | 43/42.35 |
| 4,447,981 | Bauer | May 15, 1984. | 43/42.21; 43/42.36 |
| 5,276,992 | Kato | Jan. 11, 1994 | 43/42.06 |
| 6,158,162 | Loniello | Dec. 12, 2000 | 43/42.13 |
| 6,349,498 | Garrat | Feb. 26, 2002 | 43/42.06 |
| 6,209,254 | Sylla | Apr. 3, 2001 | 43/42.09 |
| 6,219,957 | Faircloth | Apr. 24, 2001 | 43/44.93 |

### BACKGROUND

1. The No-Tie Lure connector system began at a bait store meeting between two anglers, two executives, and a storeowner. What came out of the meeting was a sincere hope to promote a new lure attachment system for fishing lures. The old system of tying a fishing line to a fishing lure can take a special knot to attach the lure to the fishing line.

### SUMMARY OF THE INVENTION

In view of the foregoing disadvantages inherent in the known types of fishing lures now present in the prior art, the present invention provides a fishing lure wherein the same may be readily attached and efficiently securable to a fishing line As such, the general purpose of the present invention, which will be described subsequently in greater detail, is to provide a new and improved fishing lure which has all the advantages of the prior art fishing lures and none of the disadvantages.

To attain this, the present invention comprises standard fishing lure. In addition to a No-Tie connector. The fishing lure is of generally round configuration, formed with a extending tab directed outwardly The fishing lure may be in various shapes and sizes.

The combination of a No-Tie lure connector will help enable securement of the lure and the line or wire.

My invention resides not in any one of these features per se, but rather in the particular combination of all of them herein disclosed and claimed and it is distinguished from the prior art in this particular combination of all of its structures for the functions specified.

There has thus been outlined, rather broadly, the more important features of the invention in order that the detailed description thereof that follows may be better understood, and in order that the present contribution to the art may be better appreciated. There are, of course additional features of the invention that will be described hereinafter and which will form the subject matter of the claims appended hereto. Those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

It is therefore an object of the present invention to provide a new and improved fishing lure and No-Tie Connector System that has all the advantages of the prior art fishing Lures and none of the disadvantages.

It is another object of the present invention to provide a new and improved Fishing Lure which may be easily and efficiently manufactured and marketed.

It is a further object of the present invention to provide a new and improved Fishing Lure which is of a durable and reliable construction.

An even further object of the present invention is to provide a new and improved Fishing Lure that is susceptible of a low cost of manufacture with regard to both materials and labor, and which accordingly is then susceptible of low prices of sale to the consuming public, thereby making such Fishing Lure economically available to the buying public.

Still yet another object of the present invention is to provide a new and improved Fishing Lure which provides in the apparatuses and methods of the prior art some of the advantages thereof, while simultaneously overcoming some of the disadvantages normally associated therewith.

Still another object of the present invention is to provide a new and improved Fishing Lure wherein the same is readily securable and releasable in association with a No-Tie Connector System.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is an illustrated preferred embodiment of the invention.

[image]

### BRIEF DESCRIPTION OF THE DRAWINGS

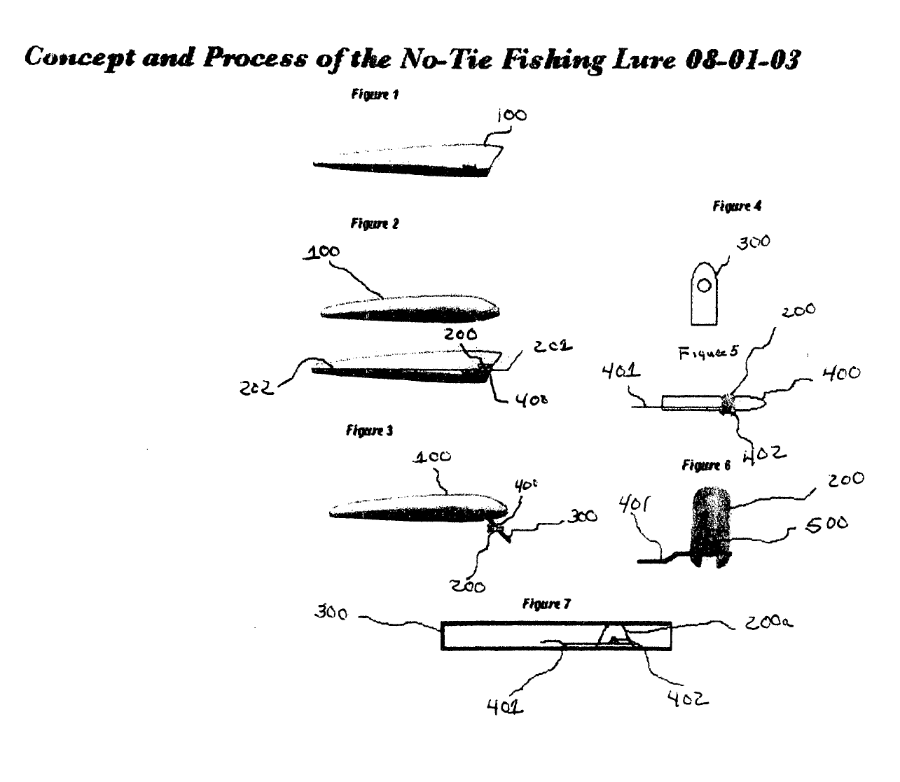

In accordance with an important feature of the present invention, there is shown in FIG. 1 a common fishing lure in general terms.

Also in common terms: in FIG. 2 is number 300 another style of fishing lure in general terms.

Also in common terms: in FIG. 4 a lip for a fishing lure.

Also in common terms: in FIG. 6 a No-Tie Lure connector.

Also in common terms: FIG. 6 number 500 a brass wedge, and No-Tie Lure connector

In our drawings, the new technology is when you incorporate: FIG. 2 number 200 a fishing lure and a No-Tie Lure connector.

In our drawings, the new technology is when you incorporate: FIG. 2 number 201 a fishing lure and a No-Tie Lure connector.

In our drawings, the new technology is when you incorporate: FIG. 2 number 202 a fishing lure and a No-Tie Lure connector.

In our drawings, the new technology is when you incorporate: FIG. 2 number 400 a fishing bill and a No-Tie Lure connector.

In our drawings, the new technology is when you incorporate: FIG. 3 number 200 a fishing lure and a No-Tie Lure connector.

In our drawings, the new technology is when you incorporate: FIG. 3 number 400 a fishing bill and a No-Tie Lure connector.

In our drawings, the new technology is when you incorporate: FIG. 5 number 400 a fishing bill and a No-Tie Lure connector

In our drawings, the new technology is when you incorporate: FIG. 5 number 401 a fishing bill, body/hook wire a No-Tie Lure connector.

In our drawings, the new technology is when you incorporate: FIG. 5 number 200 a fishing bill, and No-Tie Lure connector

In our drawings, the new technology is when you incorporate: FIG. 5 number 200 a fishing bill, and No-Tie Lure connector

In our drawings, the new technology is when you incorporate: FIG. 6 number 400 a fishing bill and a No-Tie Lure connector

In our drawings, the new technology is when you incorporate: FIG. 6 number 401 a body/hook wire a No-Tie Lure connector.

In our drawings, the new technology is when you incorporate: FIG. 6 number 200 a fishing bill, and No-Tie Lure connector

In our drawings, the new technology is when you incorporate: FIG. 7 number 200 a fishing bill, and No-Tie Lure connector

In our drawings, the new technology is when you incorporate: FIG. 7 number 200a a No-Tie Lure connector designed into a bill

In our drawings the new technology is when you incorporate: FIG. 7 number 401 a body/hook wire a No-Tie Lure connector.

### DESCRIPTION OF THE PREFERRED EMBODIMENT

With reference now to the drawings, and in particular to FIGS. 2, 3, 5, and 7 thereof, a new and improved fishing lure connection system embodying the principles and concepts of the present invention

More specifically, it will be noted that the No-Tie fishing lure 200 essentially comprises a round body 200 securable to fishing line 201 200 such as a fish lures and the like. lures of this class are typically attached with a fishing line attached to an eyelet on the fishing lure.

The No-Tie connector might have a wedge, brass etc. within.

Further, the fishing lure 100 and the no-tie connector 200 in combination as one makes this a new fishing lure.

Further, the fishing lure bill 300 and the no-tie connector 200 in combination as one makes this a new fishing lure bill 400.

As to the manner of usage and operation of the instant invention, the same should be apparent from the above description, and accordingly no further discussion relative to the manner of usage and operation of the instant invention shall be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

### DESCRIPTION OF THE PRIOR ART

In accordance with an important feature of the present invention, there is shown in FIG. 1 a common fishing lure in general terms.

Also in common terms: in FIG. 2 is number 300 another style of fishing lure in general terms.

Also in common terms: in FIG. 4 a lip for a fishing lure.

Also in common terms: in FIG. 6 a No-Tie Lure connector.

Also in common terms: FIG. 6 number 500 a brass wedge, and No-Tie Lure connector

In our drawings, the new technology is when you incorporate: FIG. 2 number 200 a fishing lure and a No-Tie Lure connector.

In our drawings, the new technology is when you incorporate: FIG. 2 number 201 a fishing lure and a No-Tie Lure connector.

In our drawings, the new technology is when you incorporate: FIG. 2 number 202 a fishing lure and a No-Tie Lure connector.

In our drawings, the new technology is when you incorporate: FIG. 2 number 400 a fishing bill and a No-Tie Lure connector.

In our drawings, the new technology is when you incorporate: FIG. 3 number 200 a fishing lure and a No-Tie Lure connector.

In our drawings, the new technology is when you incorporate: FIG. 3 number 400 a fishing bill and a No-Tie Lure connector.

In our drawings, the new technology is when you incorporate: FIG. 5 number 400 a fishing bill and a No-Tie Lure connector

In our drawings, the new technology is when you incorporate: FIG. 5 number 401 a fishing bill, body/hook wire a No-Tie Lure connector.

In our drawings, the new technology is when you incorporate: FIG. 5 number 200 a fishing bill, and No-Tie Lure connector

In our drawings, the new technology is when you incorporate: FIG. 5 number 200 a fishing bill, and No-Tie Lure connector

In our drawings the new technology is when you incorporate: FIG. 6 number 400 a fishing bill and a No-Tie Lure connector

In our drawings the new technology is when you incorporate: FIG. 6 number 401 a body/hook wire a No-Tie Lure connector.

In our drawings, the new technology is when you incorporate: FIG. 6 number 200 a fishing bill, and No-Tie Lure connector

In our drawings, the new technology is when you incorporate: FIG. 7 number 200 a fishing bill, and No-Tie Lure connector

In our drawings, the new technology is when you incorporate: FIG. 7 number 200a a No-Tie Lure connector designed into a bill

In our drawings, the new technology is when you incorporate: FIG. 7 number 401 a body/hook wire a No-Tie Lure connector.

Important Features:

In accordance with an important feature of the present invention, there is shown in FIG. 1 a common fishing lure in general terms.

Also in common terms: in FIG. 2 is number 300 another style of fishing lure in general terms.

Also in common terms: in FIG. 4 a lip for a fishing lure.

Also in common terms: in FIG. 6 a No-Tie Lure connector.

Also in common terms: FIG. 6 number 500 a brass wedge, and No-Tie Lure connector

In our drawings, the new technology is when you incorporate: FIG. 2 number 200 a fishing lure and a No-Tie Lure connector.

In our drawings, the new technology is when you incorporate: FIG. 2 number 201 a fishing lure and a No-Tie Lure connector.

In our drawings, the new technology is when you incorporate: FIG. 2 number 202 a fishing lure and a No-Tie Lure connector.

In our drawings, the new technology is when you incorporate: FIG. 2 number 400 a fishing bill and a No-Tie Lure connector.

In our drawings, the new technology is when you incorporate: FIG. 3 number 200 a fishing lure and a No-Tie Lure connector.

In our drawings, the new technology is when you incorporate: FIG. 3 number 400 a fishing bill and a No-Tie Lure connector.

In our drawings, the new technology is when you incorporate: FIG. 5 number 400 a fishing bill and a No-Tie Lure connector

In our drawings, the new technology is when you incorporate: FIG. 5 number 401 a fishing bill, body/hook wire a No-Tie Lure connector.

In our drawings, the new technology is when you incorporate: FIG. 5 number 200 a fishing bill, and No-Tie Lure connector

In our drawings, the new technology is when you incorporate: FIG. 5 number 200 a fishing bill, and No-Tie Lure connector

In our drawings, the new technology is when you incorporate: FIG. 6 number 400 a fishing bill and a No-Tie Lure connector

In our drawings, the new technology is when you incorporate: FIG. 6 number 401 a body/hook wire a No-Tie Lure connector.

In our drawings, the new technology is when you incorporate: FIG. 6 number 200 a fishing bill, and No-Tie Lure connector

In our drawings, the new technology is when you incorporate: FIG. 7 number 200 a fishing bill, and No-Tie Lure connector

In our drawings the new technology is when you incorporate: FIG. 7 number 200a a No-Tie Lure connector designed into a bill

In our drawings, the new technology is when you incorporate: FIG. 7 number 401 a body/hook wire a No-Tie Lure connector.

Important Keys

A fishing lure that does not tie directly on to a fishing line. A fishing lure that does not tie directly on to a fishing wire. A fishing line that does not tie directly on to an eyelet. A fishing wire that does not tie directly on to an eyelet. A fishing connector does connect by a no-tie lure connector and a fishing line. A fishing connector that does connect by a no-tie lure connector and a fishing wire.

A fishing lure that does not tie directly on to a fishing line. A fishing lure that does not tie directly on to a fishing wire.

A fishing lure that does connect by a no-tie lure connector and a fishing line. A fishing lure that does connect by a no-tie lure connector and a fishing wire.

1. A process for No-Tie Lure System comprising the steps of:

2. A fishing lure that does not tie directly on to a fishing line;
a. A fishing line that does not tie directly on to an eyelet.

3. A fishing lure that does not tie directly on to a fishing wire;
a. A fishing wire that does not tie directly on to an eyelet.

4. A fishing lure that does not tie directly on to a fishing line;

5. A fishing lure that does not tie directly on to a fishing wire;

6. A fishing lure that does connect by a no-tie lure connector and a fishing line; or

7. A fishing lure that does connect by a no-tie lure connector and a fishing wire.

8. A Process of installing a No-Tie component within a Lure comprising the steps of: providing a fishing lure, and a No-Tie device for tying the lure on a fishing line.

9. A Process providing a fishing lure, and a No-Tie device for tying the lure on a fishing line wire.

10. A Process further comprises the step of not tying directly to a lure.

11. A Process of installing a No-Tie component within a Lure comprising the steps of: providing a fishing lure, and a No-Tie device for tying the lure on a fishing line.

12. A Process providing a fishing lure, and a No-Tie device for tying the lure on a fishing line wire.

13. A Process further comprises the step of not tying directly to a lure.
